(19) United States
(12) Patent Application Publication
(10) Pub. No.: US 2025/0262708 A1
(43) Pub. Date: Aug. 21, 2025

(54) Emergency Tool Stop Device

(71) Applicants: Tallon Smith, Belleville, IL (US); Brian Taylor, Belleville, IL (US)

(72) Inventors: Tallon Smith, Belleville, IL (US); Brian Taylor, Belleville, IL (US)

(21) Appl. No.: 19/006,332

(22) Filed: Dec. 31, 2024

Related U.S. Application Data
(60) Provisional application No. 63/553,783, filed on Feb. 15, 2024.

(51) Int. Cl. B24B 23/02; B23Q 11/00; B24B 47/26; B24B 55/05; F16P 7/02

(52) U.S. Cl. CPC B24B 23/02; B23Q 11/0092; B24B 47/26; B24B 55/052; F16P 7/02

(57) ABSTRACT

An emergency tool stop device is provided. The device may be attached to any existing grinder and has a guard that partially encircles at least one cutting/grinding blade and incorporates a fastener mechanism for attaching components such as a disk brake, washer, cutting blade, and retaining nut. The washer prevents the brake from pressing on the blade, while the nut secures the assembly to the guard. Furthermore, the device is equipped with a brake lever that attaches to the grinder's handle with a fastener and connects to a brake pad via a cable. While using the grinder, the lever can be depressed while a user grips the handle of the grinder where the lever is installed. Once released (i.e., in the event of a drop) the lever activates the brake pad which stops the blade's rotation by bringing the brake pad into contact with the blade.

### CROSS-REFERENCE TO RELATED APPLICATION

The present application claims priority to, and the benefit of, U.S. Provisional Application No. 63/553,783, which was filed on Feb. 15, 2024, and is incorporated herein by reference in its entirety.

### FIELD OF THE INVENTION

The present invention relates generally to the field of rotational blade tool safety accessories. More specifically, the present invention relates to an emergency tool stop device that can be applied to a grinder (or other similar tool) to stop the rotation of the blade in the event that the tool is dropped unintentionally. Accordingly, the present disclosure makes specific reference thereto. Nonetheless, it is to be appreciated that aspects of the present invention are also equally applicable to other like applications, devices, and methods of manufacture.

### BACKGROUND

The operation of grinders and the inherent risks associated with their use, particularly concerning the blades' capacity to continue rotating after the device has been dropped or intentionally powered down, necessitates a comprehensive understanding and strict adherence to safety measures to mitigate potential hazards. This phenomenon, where the momentum of the heavy, grinder blades enables the blade to maintain rotation independently of the power source, poses an unexpected and often underestimated danger to operators.

For example, in scenarios where a grinder is accidentally dropped, the force of impact might not immediately halt the blades' rotation, instead potentially causing the blade to spin out of control or project dangerous debris. Similarly, when the power is switched off, the blade might not cease movement instantaneously due to built-up kinetic energy, creating a window of time during which the blade is still capable of inflicting severe injuries. These injuries can range from superficial cuts and lacerations to more critical, potentially life-altering traumas such as deep tissue damage, nerve injuries, or even amputations, should the user inadvertently come into contact with the blades while they are still in motion.

Therefore, there exists a long-felt need in the art for a safety device for grinders and similar devices. There also exists a long-felt need in the art for an emergency tool stop device. More specifically, there exists a long-felt need in the art for an emergency tool stop device that improves the safety of a grinder or other similar rotational blade tool. In addition, there exists a long-felt need in the art for an emergency tool stop device that improves the safety of a grinder or other similar rotational blade tool by stopping the rotation of a tool blade when the tool is dropped and/or no longer powered on.

The subject matter disclosed and claimed herein, in one embodiment thereof, comprises an emergency tool stop device. The device may be attached to any existing grinder/angle grinder or comprise a grinder/angle grinder with standard features. This device includes at least one guard that partially encircles at least one cutting/grinding blade and incorporates a fastener mechanism for attaching components such as a disk brake, washer, cutting blade, and retaining nut, ensuring these components remain attached during use. The washer prevents the brake from pressing on the blade, while the nut secures the assembly to the guard. Furthermore, the device is equipped with a brake lever that attaches to the grinder's handle with a fastener and connects to a brake pad via a cable. While using the grinder, the lever can be depressed while a user grips the handle of the grinder where the lever is installed. Once released (i.e., in the event of a drop) the lever activates the brake pad which stops the blade's rotation by bringing the brake pad into contact with the blade.

In this manner, the emergency tool stop device of the present invention accomplishes all the foregoing objectives and provides a safety device for grinders and similar devices. More specifically, the device improves the safety of a grinder or other similar rotational blade tool by stopping the rotation of a tool blade when the tool is dropped and/or no longer powered on via the brake pad. This ensures injuries cannot occur if the tool is unintentionally dropped.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an emergency tool stop device. The device can preferably be attached to any existing grinder/angle grinder known in the art. In another embodiment, the device is comprised of a grinder/angle grinder with all known angle grinder features.

The device is comprised of at least one guard. The guard partially surrounds at least one cutting/grinding blade. The guard is also comprised of at least one fastener that allows at least one disk brake, at least one washer, at least one cutting blade, and at least one retaining nut to attach to the guard. The washer prevents the brake from pushing on the blade during use. The nut ensures the brake, washer, and blade remain attached to the guard during use.

The device is also comprised of at least one brake lever that can be attached around a handle of a grinder via at least one fastener such as, but not limited to, a threaded clamp. The brake lever is connected to at least one brake pad via at least one brake cable. During use of the grinder, a user grips (i.e., pulls in) the lever. Once the lever is released, the brake pad contacts the blade to stop rotation of the blade. This ensures that if the grinder is dropped the blade stops spinning before contacting a ground surface.

The present invention is also comprised of a method of using the device. First, a device is provided comprised of at least one guard, at least one cutting blade, at least one brake lever, and at least one brake pad. Then, the guard and blade can be secured to a grinder. Next, the brake lever can be secured around a handle of the grinder via at least one fastener. Then, a user can depress the brake lever while gripping the handle such that the brake pad does not contact the blade. Finally, a user can release the brake lever to cause the brake pad to contact and stop the rotation of the blade.

Accordingly, the emergency tool stop device of the present invention is particularly advantageous as it provides a safety device for grinders and similar devices. More specifically, the device improves the safety of a grinder or other similar rotational blade tool by stopping the rotation of a tool blade when the tool is dropped and/or no longer powered on via the brake pad. This ensures injuries cannot occur if the tool is unintentionally dropped. In this manner, the emergency tool stop device overcomes the limitations of existing grinder tools known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of an emergency tool stop device of the present invention in accordance with the disclosed architecture;

FIG. 2 illustrates a perspective view of a guard of one potential embodiment of an emergency tool stop device of the present invention in accordance with the disclosed architecture;

FIG. 3 illustrates an exploded view of one potential embodiment of an emergency tool stop device of the present invention in accordance with the disclosed architecture;

FIG. 4 illustrates a perspective view of one potential embodiment of an emergency tool stop device of the present invention in accordance with the disclosed architecture; and

FIG. 5 illustrates a flowchart of a method of using one potential embodiment of an emergency tool stop device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a safety device for grinders and similar devices. There also exists a long-felt need in the art for an emergency tool stop device. More specifically, there exists a long-felt need in the art for an emergency tool stop device that improves the safety of a grinder or other similar rotational blade tool. In addition, there exists a long-felt need in the art for an emergency tool stop device that improves the safety of a grinder or other similar rotational blade tool by stopping the rotation of a tool blade when the tool is dropped and/or no longer powered on.

The present invention, in one exemplary embodiment, is comprised of an emergency tool stop device that can preferably be attached to any existing grinder/angle grinder known in the art. In another embodiment, the device is comprised of a grinder/angle grinder with all known angle grinder features.

The device is comprised of at least one guard that partially surrounds at least one cutting/grinding blade. The guard is also comprised of at least one fastener that allows at least one disk brake, at least one washer, at least one cutting blade, and at least one retaining nut to attach to the guard. The washer prevents the brake from pushing on the blade during use. The nut ensures the brake, washer, and blade remain attached to the guard during use.

The device is also comprised of at least one brake lever. The lever can be attached around a handle of a grinder via at least one fastener such as, but not limited to, a threaded clamp. The brake lever is connected to at least one brake pad via at least one brake cable. During use of the grinder, a user grips (i.e., pulls in) the lever. Once the lever is released, the brake pad contacts the blade to stop rotation of the blade. This ensures that if the grinder is dropped the blade stops spinning before contacting a ground surface.

The present invention is also comprised of a method of using the device. First, a device is provided comprised of at least one guard, at least one cutting blade, at least one brake lever, and at least one brake pad. Then, the guard and blade can be secured to a grinder. Next, the brake lever can be secured around a handle of the grinder via at least one fastener. Then, a user can depress the brake lever while gripping the handle such that the brake pad does not contact the blade. Finally, a user can release the brake lever to cause the brake pad to contact and stop the rotation of the blade.

Accordingly, the emergency tool stop device of the present invention is particularly advantageous as it provides a safety device for grinders and similar devices. More specifically, the device improves the safety of a grinder or other similar rotational blade tool by stopping the rotation of a tool blade when the tool is dropped and/or no longer powered on via the brake pad. This ensures injuries cannot occur if the tool is unintentionally dropped. In this manner, the emergency tool stop device overcomes the limitations of existing grinder tools known in the art.

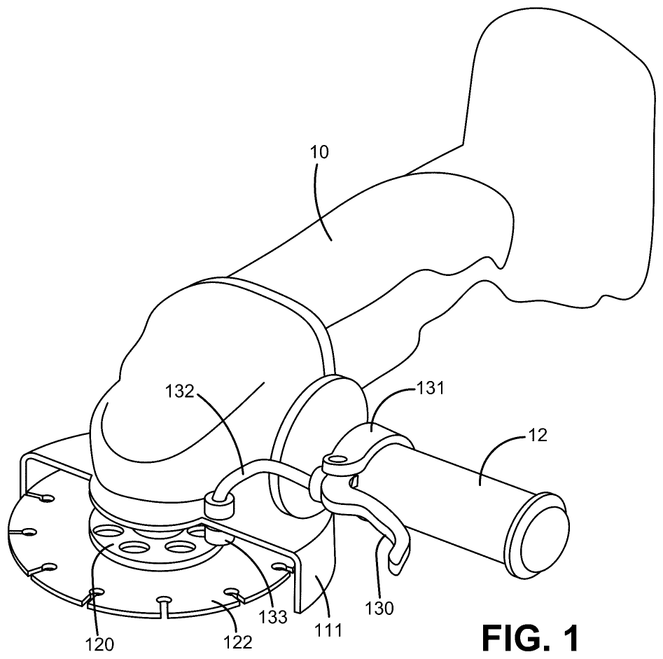

Referring initially to the drawings, FIG. 1 illustrates a perspective view of one potential embodiment of an emergency tool stop device 100 of the present invention in accordance with the disclosed architecture. The device 100 can preferably be attached to any existing grinder/angle grinder known in the art. In another embodiment, the device 100 is comprised of a grinder/angle grinder 10 with all known angle grinder features.

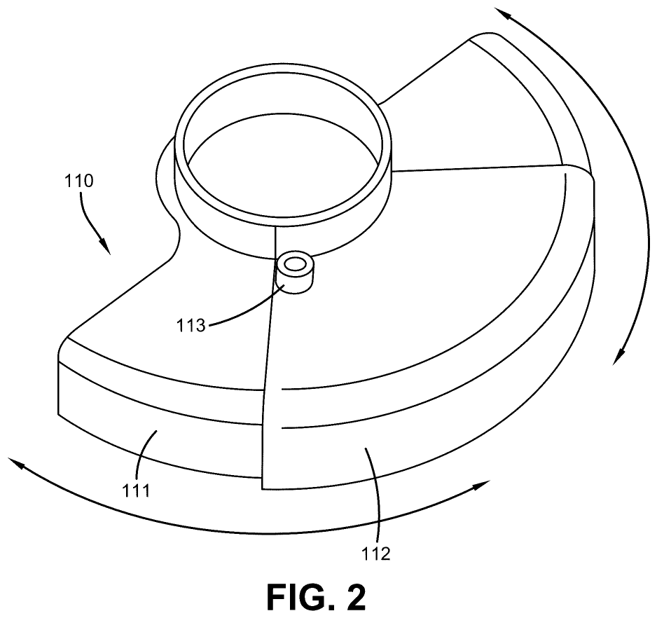

In addition, the device 100 is comprised of at least one guard 110, as seen in FIG. 2. The guard 110 partially surrounds at least one cutting/grinding blade 122. The blade 122 may be any size, shape, and configuration of grinding and/or cutting blade known in the art and may be made of any material. In one embodiment, the guard 110 is comprised of a body 111 with at least one movable member 112. The member 112 can be rotated around the body 111 to provide more or less coverage as needed. The member 112 can be locked in a desired position via at least one locking member 113 such as, but not limited to, a button lock. During use, the guard 110 prevents debris/sparks from contacting a user.

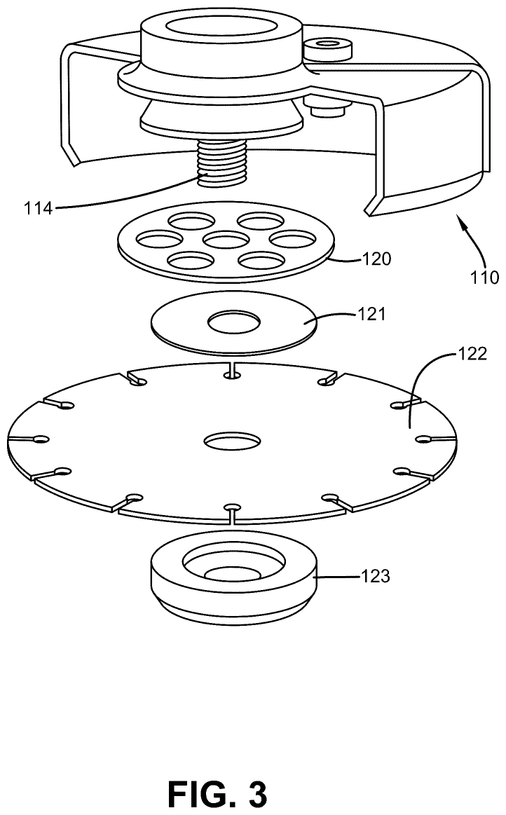

The guard 110 is also comprised of at least one fastener 114, such as, but not limited to, a male threaded fastener, as seen in FIG. 3. The fastener 114 allows at least one disk brake 120, at least one washer 121, at least one cutting blade 122, and at least one retaining nut 123 to attach to the guard 110. The washer 121 prevents the brake 120 from pushing on the blade 122 during use. The nut 123 ensures the brake 120, washer 121, and blade 122 remain attached to the guard 110 during use.

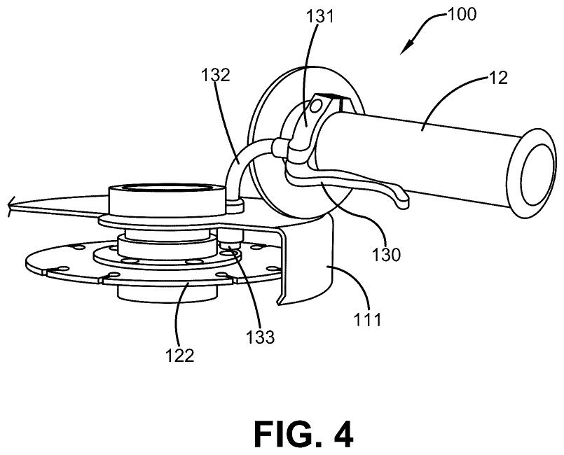

The device 100 is also comprised of at least one brake lever 130. The lever 130 can be attached around a handle 12 of a grinder 10, as seen in FIG. 1. and FIG. 4. More specifically, the lever 130 is secured around the handle 12 via at least one fastener 131 such as, but not limited to, a threaded clamp. The brake lever 130 is connected to at least one brake pad 133 (preferably made of rubber, metal, etc.,) via at least one brake cable 132. During use of the grinder 10, a user grips (i.e., pulls in) the lever 130. Once the lever 130 is released, the brake pad 133 contacts the blade 122 to stop rotation of the blade 122. This ensures that if the grinder 10 is dropped the blade 122 stops spinning before contacting a ground surface.

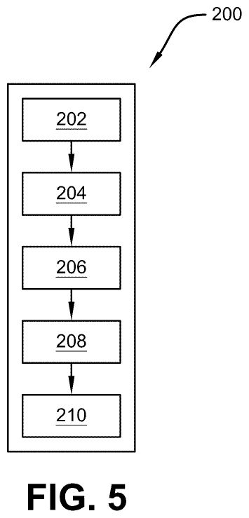

The present invention is also comprised of a method of using 200 the device 100, as seen in FIG. 5. First, a device 100 is provided comprised of at least one guard 110, at least one cutting blade 122, at least one brake lever 130, and at least one brake pad 133 [Step 202]. Then, the guard 110 and blade 122 can be secured to a grinder 10 [Step 204]. Next, the brake lever 130 can be secured around a handle 12 of the grinder 10 via at least one fastener 131 [Step 206]. Then, a user can depress the brake lever 130 while gripping the handle 12 such that the brake pad 133 does not contact the blade 122 [Step 208]. Finally, a user can release the brake lever 130 to cause the brake pad 133 to contact and stop the rotation of the blade 122 [Step 210].

It should be appreciated that the device 100 can be applied to and/or comprised of any tool/device comprised of a rotary cutting blade, and is not limited to only an angle grinder. This includes, but is not limited to, angle grinders, cut-off grinders, concrete saws, demolition saws, air grinders, electric grinders, bench grinders, etc.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “emergency tool stop device” and “device” are interchangeable and refer to the emergency tool stop device 100 of the present invention.

Notwithstanding the foregoing, the emergency tool stop device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the emergency tool stop device 100 as shown in the FIGS. are for illustrative purposes only, and that many other sizes and shapes of the emergency tool stop device 100 are well within the scope of the present disclosure. Although the dimensions of the emergency tool stop device 100 are important design parameters for user convenience, the emergency tool stop device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An emergency tool stop device comprising:
a guard;
a brake lever;
a disk brake;
a fastener;
a brake cable; and
a brake pad.

2. The emergency tool stop device of claim 1, wherein the guard is comprised of a movable member.

3. The emergency tool stop device of claim 1 further comprised of a washer.

4. The emergency tool stop device of claim 1 further comprised of a retaining nut.

5. The emergency tool stop device of claim 1, wherein the brake pad is comprised of a rubber material or a metal material.

6. The emergency tool stop device of claim 1, wherein the brake cable connects the brake pad to the brake lever.

7. The emergency tool stop device of claim 1, wherein the fastener is comprised of a threaded clamp.

8. An emergency tool stop device comprising:
a guard;
a brake lever;
a disk brake;
a fastener;
a cutting blade;
a brake cable; and
a brake pad.

9. The emergency tool stop device of claim 8, wherein the guard is comprised of a movable member.

10. The emergency tool stop device of claim 9, wherein the position of the movable member on the guard can be secured via a locking member.

11. The emergency tool stop device of claim 8 further comprised of a washer.

12. The emergency tool stop device of claim 8 further comprised of a retaining nut.

13. The emergency tool stop device of claim 8, wherein the brake pad is comprised of a rubber material or a metal material.

14. The emergency tool stop device of claim 8, wherein the brake cable connects the brake pad to the brake lever.

15. The emergency tool stop device of claim 8, wherein the fastener is comprised of a threaded clamp.

16. The emergency tool stop device of claim 8, wherein the guard is comprised of a male threaded fastener.

17. A method of using an emergency tool stop device, the method comprising the following steps:
providing an emergency tool stop device comprised of a guard, a cutting blade, a brake lever, and a brake pad;
securing the guard and the cutting blade to a grinder;
securing the brake lever around a handle of the grinder via a fastener;
depressing the brake lever while gripping the handle; and
releasing the brake lever to pause the brake pad to contact and stop the rotation of the cutting blade.

18. The method of using an emergency tool stop device of claim 17, wherein the brake pad is comprised of a metal material.

19. The method of using an emergency tool stop device of claim 17, wherein the brake pad is comprised of a rubber material.

20. The method of using an emergency tool stop device of claim 17, wherein the emergency tool stop device is comprised of a disk brake.
